(19) United States
(12) Patent Application Publication
(10) Pub. No.: US 2020/0257121 A1
(43) Pub. Date: Aug. 13, 2020

(54) INFORMATION PROCESSING METHOD, INFORMATION PROCESSING TERMINAL, AND COMPUTER-READABLE NON-TRANSITORY STORAGE MEDIUM STORING PROGRAM

(71) Applicant: Mercari, Inc., Tokyo (JP)

(72) Inventor: Satoshi YANAGISAWA, Tokyo (JP)

(21) Appl. No.: 16/782,768

(22) Filed: Feb. 5, 2020

(30) Foreign Application Priority Data
Feb. 7, 2019 (JP) 2019-020953
May 14, 2019 (JP) 2019-091433

(51) Int. Cl. G02B 27/01; G06T 19/00; G06F 3/01; G02B 27/00; G06T 19/20

(52) U.S. Cl. CPC G02B 27/0172; G06T 19/006; G06F 3/011; G02B 2027/0178; G02B 27/0093; G06T 19/20; G06T 2219/2016; G06F 3/017

(57) ABSTRACT

In order to allow a user to easily check detailed information on an object put in front of the user, such as information on the inside of the object without remaining in the same place, provided is an information processing method performed by an information processing terminal includes acquiring an image captured by an imaging unit and positional information representing a position of the information processing terminal; transmitting the image and the positional information to an information processing apparatus; receiving, from the information processing apparatus, data of a three-dimensional model of an object specified using the image and the positional information; estimating a sight-line direction of a user who uses the information processing terminal on the basis of sensor information measured by an acceleration sensor and a magnetic sensor; specifying display data of the three-dimensional model using the sight-line direction; and outputting the display data.

### CROSS-REFERENCE TO RELATED APPLICATIONS

This application claims the benefit of foreign priority to Japanese Patent Application No. 2019-020953, filed Feb. 7, 2019, and Japanese Patent Application No. 2019-091433, filed May 14, 2019, the content of which is incorporated herein by reference.

### BACKGROUND

### Field

The present invention relates to an information processing method, an information processing terminal, and a computer-readable non-transitory

### Description of Related Art

Conventionally, there have been glasses type and head mount display type wearable terminals used by being worn on the head of a user. These wearable terminals can display predetermined information to a user and the user can confirm the information displayed over a real scene while viewing the real scene.

For example, Redshift, “See through Walls with Augmented Reality in the construction industry”, [online], Jun. 14, 2017, Mogura V R, [search on Feb. 7, 2019], Internet <URL: https://www.moguravr.com/ar-in-construction-redshift/>discloses a technology in which, when a user wearing a helmet type wearable terminal walks in a construction site, the user can see through the off side of a wall and thus can check, for example, heating ducts, water pipes, control panels and the like, and if a layer of a three-dimensional model is stripped off, the user can also check still-frame structures, insulation of buildings, and processing and surface treatment of materials.

### SUMMARY

However, in the above-described conventional technology, a user needs to load a model of a construction site in advance in order to confirm information, and thus when the construction site changes, the user has to load a model corresponding to the construction site each time. In addition, there are cases in which a user wants to ascertain detailed information such as the inside and a current state of an object (e.g., a store, a hotel, a delivery person of a parcel delivery service, or the like) that the user does not ascertain yet while the user is outside the object, for example, while walking on the street.

Accordingly, an object of the present disclosure is to provide an information processing method, an information processing terminal, and a computer-readable non-transitory storage medium storing a program which can allow a user to easily confirm detailed information about an object in front of the user, such as the inside of the object, while the user is in the same place.

According to one aspect of the present disclosure, an information processing method performed by an information processing terminal includes: acquiring an image captured by an imaging unit and positional information representing a position of the information processing terminal; transmitting the image and the positional information to an information processing apparatus; receiving, from the information processing apparatus, data of a three-dimensional model of an object specified using the image and the positional information; estimating a sight-line direction of a user who uses the information processing terminal on the basis of sensor information measured by an acceleration sensor and a magnetic sensor; specifying display data of the three-dimensional model using the sight-line direction; and outputting the display data.

According to the present disclosure, it is possible to allow a user to easily confirm detailed information about an object in front of the user, such as the inside of the object, while remaining in the same place.

### BRIEF DESCRIPTION OF DRAWINGS

FIG. 1 is a diagram for explaining a system overview according to a first embodiment;

FIG. 2 is a diagram showing a communication system 1 according to the first embodiment;

FIG. 3 is a diagram showing an example of a hardware configuration of a server 110 according to the first embodiment;

FIG. 4 is a diagram showing an example of a hardware configuration of an information processing terminal 130 according to the first embodiment;

FIG. 5 is a diagram showing an example of the exterior of a wearable terminal 130A according to the first embodiment;

FIG. 6 is a diagram showing an example of each function of the server 110 according to the first embodiment;

FIG. 7 is a diagram showing an example of each function of the information processing terminal 130 according to the first embodiment;

FIG. 8 is a diagram for explaining an example of a see-through function and a display magnification change function according to the first embodiment;

FIG. 9 is a diagram for explaining an example of a panorama function according to the first embodiment;

FIG. 10 is a diagram for explaining an example of a text display function according to the first embodiment;

FIG. 11 is a diagram for explaining an example of a control information confirmation function according to the first embodiment;

FIG. 12 is a sequence diagram showing an example of processing performed by the communication system 1 according to the first embodiment;

FIG. 13 is a diagram for explaining a system overview according to a second embodiment;

FIG. 14 is a diagram showing an example of a hardware configuration of a server 110 according to the second embodiment;

FIG. 15 is a sequence diagram showing an example of processing performed by the communication system 1 according to the second embodiment;

FIG. 16 is a diagram for explaining a system overview according to a third embodiment; and

FIG. 17 is a sequence diagram showing an example of processing performed by the communication system 1 according to the third embodiment.

### DETAILED DESCRIPTION

Embodiments of the present disclosure will be described with reference to the attached drawings. Meanwhile, the same or similar components are denoted by the same reference signs in each drawing.

### First Embodiment

### System Overview

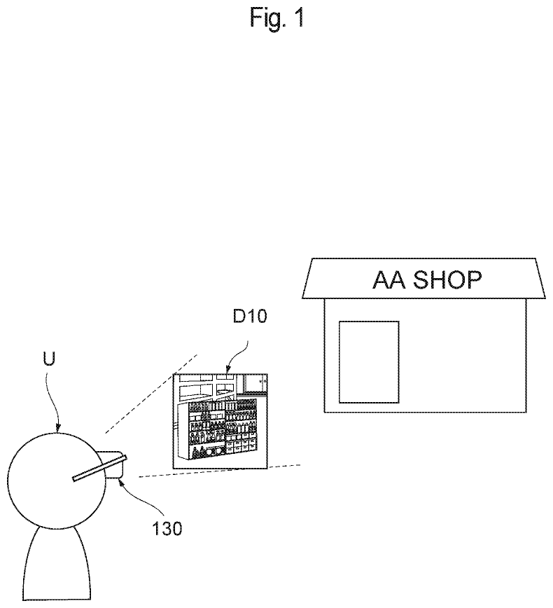

FIG. 1 is a diagram for explaining an overview of a communication system according to a first embodiment. In the example shown in FIG. 1, a store is used as an example of an object and glasses having an imaging unit and an output unit are used as an example of an information processing terminal 130. It is assumed that a user U wearing the information processing terminal 130 discovers AA shop that is a store the user has not visited yet while walking along a street. Here, the user U performs a simple operation (e.g., a predetermined gesture) while viewing the AA shop, for example, such that the information processing terminal 130 transmits positional information and an image of the AA shop to a server.

Subsequently, the server acquires a three-dimensional model representing the inside of the object on the basis of positional information and the image of the object and transmits data of the three-dimensional model to the information processing terminal 130. The information processing terminal 130 displays at least a part of display data D10 of the acquired three-dimensional model such that the display data is overlaid on a real space. Displaying the display data such that the display data is overlaid on the real space includes displaying the display data of the 3D model through a lens of glasses or the like such that the display data is overlaid on the real space, including the display data of the 3D model in an image captured by the imaging unit while allowing the user to view the image through a display screen as a real space, and the like.

Although the example shown in FIG. 1 represents that the information processing terminal 130 outputs display data D10 on a space in front of the user using a projector type, the present disclosure is not limited thereto and the display data D10 may be displayed on a lens of the information processing terminal 130 or the display data D10 may be displayed on the retina of the user. Furthermore, the information processing terminal 130 may be an information processing terminal of a glasses type, a head mount display type, a smartphone, or the like.

Accordingly, when the user is in front of an object of which he or she is not familiar with the inside, the user can easily confirm the inside of the object, that is, easily execute a see-through function because display data representing the inside of the object is displayed over the real space.

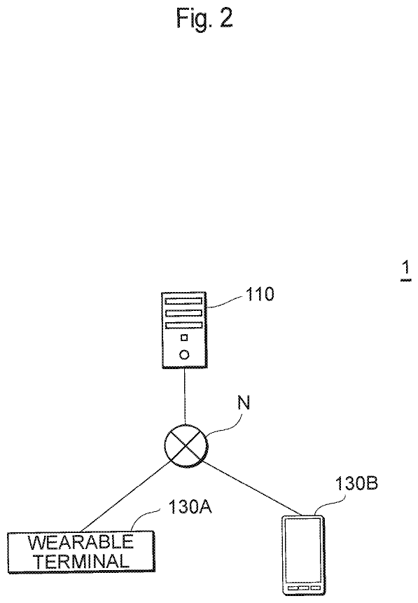

FIG. 2 is a diagram showing a communication system 1 according to the first embodiment. The communication system 1 which can execute processing related to the example shown in FIG. 1 includes a server (information processing apparatus) 110, a wearable terminal 130A, and a terminal 130B. The server 110, the wearable terminal 130A and the terminal 130B are connected through a communication network N such as the Internet, a wireless LAN, Bluetooth (registered trademark) or wired communication such that they can communicate with each other. Meanwhile, the numbers of the servers 110, the wearable terminals 130A, and the terminals 130B included in the communication system 1 are not limited to one and the communication system 1 may include a plurality of servers 110, wearable terminals 130A and terminals 130B. In addition, the server 110 may be composed of one apparatus or a plurality of apparatuses and may be a server realized on a cloud.

The wearable terminal 130A is an electronic device worn by a user. For example, the wearable terminal 130A may be a glasses type terminal (smart glasses), a contact lens type terminal (smart contact lens), a head mount display, an artificial eye, or the like which can use an augmented reality (AR) technology. Meanwhile, the wearable terminal is not limited to terminals using an AR technology and may be a terminal using a technology such as mediated reality, mixed reality, virtual reality or diminished reality.

The terminal 130B may be a smartphone, tablet terminal, cellular phone, personal computer (PC), personal digital assistant (FDA), home game device or the like having an imaging unit and an output unit, for example. Hereinafter, when the wearable terminal 130A and the terminal 130B are not distinguished from each other, they will be collectively referred to as an information processing terminal 130. Furthermore, in the present embodiment, a glasses type terminal (smart glasses) of the wearable terminal 130A will be described as an example of the information processing terminal 130.

Hardware Configuration

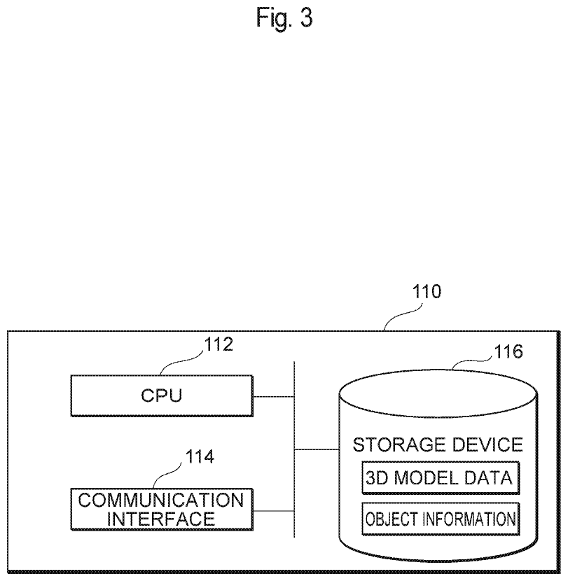

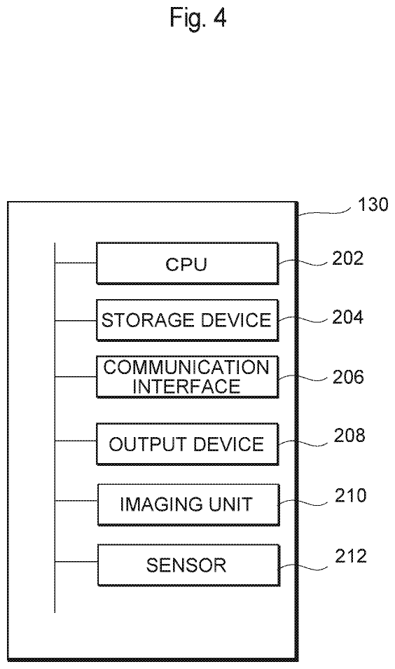

Hardware of each apparatus of the communication system 1 will be described. Hardware of the server (information processing apparatus) 110 which specifies a 3D model using positional information and an image of an object will be described using FIG. 3 and hardware of the information processing terminal 130 which outputs the 3D model acquired from the server 110 will be described using FIG. 4.

Hardware of Server 110

FIG. 3 is a diagram showing an example of a hardware configuration of the server 110 according to the first embodiment. The server 110 includes a central processing unit (CPU) 112, a communication interface (IF) 114 and a storage device 116. These components are connected such that they can transmit and receive data.

The CPU 112 is a control unit which performs control with respect to execution of programs stored in the storage device 116 and operation and processing of data. The CPU 112 may receive data from the communication IF 114 and output a data operation result to an output device or store the data operation result in the storage device 116.

The communication IF 114 is a device which connects the server 110 to the communication network N. The communication IF 114 may be provided outside the server 110. In this case, the communication IF 114 is connected to the server 110 through an interface such as a Universal Serial Bus (USB), for example.

The storage device 116 is a device which stores various types of information. The storage device 116 may be a volatile storage medium which can rewrite data or a non-volatile storage medium which can only read data.

The storage device 116 stores, for example, data of a three-dimensional (3D) model representing the exterior and/or the inside of an object and object information representing information about the object. The 3D model may be generated on the basis of image information of the inside, and the like provided by a predetermined user, for example. The predetermined user may be a user in a store, a user of a store, or a system provider. In addition, the 3D model may be generated by a system provider, a vendor requested by the system provider, or the like. Further, the 3D model may be generated in real time. Moreover, the 3D model may store image data of the exterior as well as the inside for matching processing which will be described later.

The object information may include, for example, the name of the object and information about the inside of the object. When the object is a store, the object information includes the name of the store, products for sale, prices of products, and the like. In addition, when the object is an accommodation, the object information includes the name of the accommodation, the type of the accommodation (a motel, a business hotel, or the like), an overview of each room, facilities of each room, and the like. Furthermore, when the object is a device or the like, the object information includes the name of the device, the names of internal components of the device, and the like. When the object is a person, the object information includes emotions, clothes and the like registered in advance by the person. In addition, the object information may be stored using a hierarchical structure from a higher rank to a lower rank to be connected with a display magnification which will be described later.

Further, when control information about each position of an object is acquired from an external system which will be described layer, the storage device 116 may store the control information. The control information may be, for example, vacancy information about each room of a hotel or vacancy information about each seat of a restaurant.

Hardware of Information Processing Terminal 130

FIG. 4 is a diagram showing an example of a hardware configuration of the information processing terminal 130 according to the first embodiment. The information processing terminal 130 includes a CPU 202, a storage device 204, a communication IF 206, an output device 208, an imaging unit 210, and a sensor 212. These components are connected such that they can transmit and receive data. The CPU 202, the storage device 204, and the communication IF 206 shown in FIG. 4 have the same configurations as those of the CPU 112, the storage device 116, and the communication IF 114 included in the server 110 shown in FIG. 3 and thus description thereof is omitted. Meanwhile, when 3D model data and object information are acquired from the server 110, the storage device 204 of the information processing terminal 130 stores this information.

The output device 208 is a device for outputting information. For example, the output device 208 may be a liquid crystal display, an organic electronic luminescent (EL) display, a speaker, a projector which projects information on an object surface, a space or a retina, or the like.

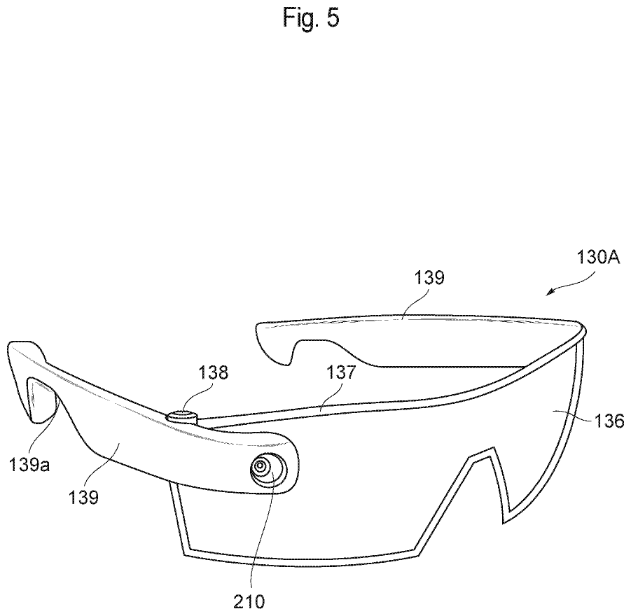

The imaging unit 210 is a device for capturing images (including still images and moving images). For example, the imaging unit 210 may include an imaging element such as a CCD image sensor, a CMOS image sensor, a lens, or the like. The imaging unit 210 is provided at a position at which it captures an image in a sight-line direction of a user in the case of the smart glasses type wearable terminal 130A (refer to FIG. 5, for example).

The sensor 212 includes at least an acceleration sensor and a magnetic sensor and may further include an angular velocity sensor. The sensor 212 may acquire azimuth information and the like as sensor information, for example. With respect to the azimuth information, appropriate azimuth information may be acquired by correcting the inclination of the magnetic sensor using data from the acceleration sensor.

Meanwhile, the information processing terminal 130 may include an input device or the like according to the terminal type. For example, when the information processing terminal 130 is a smartphone or the like, the information processing terminal 130 includes an input device. The input device is a device for receiving input of information from a user. The input device may be a touch panel, a button, a keyboard, a mouse, a microphone, or the like, for example.

Exterior of Wearable Terminal 130A

FIG. 5 is a diagram showing an example of the exterior of the wearable terminal 1301 according to the first embodiment. The wearable terminal 130A includes an imaging unit 210, a display 136, a frame 137, a hinge part 138, and temples 139.

As described above, the imaging unit 210 is a device for capturing an image. The imaging unit 210 may include an imaging element such as a CCD image sensor, a CMOS image sensor, or a lens which is not shown. The imaging unit 210 may be provided at a position at which an image can be captured in a sight-line direction of a user.

The display 136 is an output device 208 which displays various types of information such as product information on the basis of control of an output unit 412 which will be described later. The display 136 may be formed using a member which transmits visible light such that a user wearing the wearable terminal 130A can view a scene of a real space. For example, the display 136 may be a liquid crystal display or an organic EL display using a transparent substrate.

The frame 137 is provided to surround the outer circumference of the display 136 and protects the display 136 from an impact and the like. The frame 137 may be provided over the entire outer circumference of the display 136 or provided at a part thereof. The frame 137 may be formed of a metal, a resin, or the like, for example.

The hinge part 138 connects the temples 139 to the frame 137 such that the temples 139 can rotate with respect to the frame 137. The temples 139 are bows extending from both ends of the frame 137 and may be formed of a metal, a resin, or the like, for example. The wearable terminal 130A is worn by a user such that the temples 139 opened away from the frame 137 are positioned near the temple of the user.

The temples 139 include a partially recessed locking portion 139a. The locking portion 139a is positioned to sit on the ears of the user in a state in which the wearable terminal 130A is worn by the user and prevents the wearable terminal 130A from falling off of the head of the user.

Functional Configuration

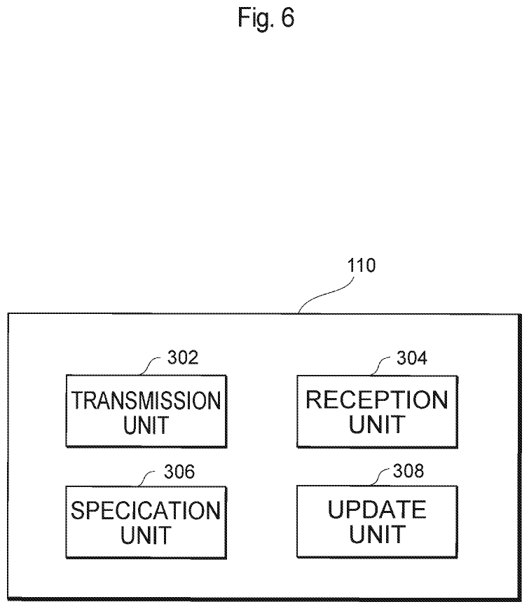

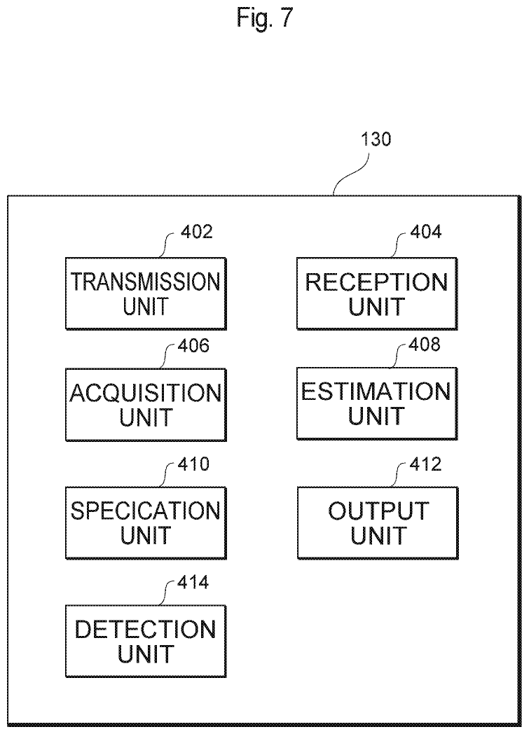

Next, the function of each device of the communication system 1 will be described. Each function of the server 110 which specifies a 3D model using positional information and an image of an object will be described using FIG. 6 and each function of the information processing terminal 130 which outputs the 3D model acquired from the server 110 will be described using FIG. 7.

Functional Configuration of Server

FIG. 6 is a diagram showing an example of each function of the server 110 according to the first embodiment. In the example shown in FIG. 6, the server 110 includes a transmission unit 302, a reception unit 304, a specifying unit 306, and an update unit 308. The transmission unit 302, the reception unit 304, the specifying unit 306 and the update unit 308 can be realized by the CPU 112 of the server 110 executing a program stored in the storage device 116.

The transmission unit 302 transmits predetermined information to the information processing terminal 130 through the communication network N. The predetermined information may be data of a 3D model of an object, object information, and the like, for example.

The reception unit 304 receives predetermined information from the information processing terminal 130 through the communication network N.

The predetermined information may be positions information of the information processing terminal 130, a captured image of an object, and the like, for example.

The specifying unit 306 specifies data of a single three-dimensional model (3D model) from among data of 3D models of a plurality of objects stored in the storage device 116 using a captured image of an object and the positional information. A 3D model may be a 3D model of an object, for example, in which the object three-dimensionally modeled from the exterior to the inside of the object, and which is associated with positional information (e.g., information of latitude and longitude) indicating a position at which the object is present in a real space. In addition, positional information and 3D models may be associated with each other in one to N (multiple) or one to one manner.

In addition, the 3D model is not limited to a 3D model of an object and may be generated in a form close to a real space including roads and streets. In this case, positional information is associated with a characteristic part (an object, a road, a building, or the like) of the 3D model.

For example, the specifying unit 306 specifies an object within a predetermined range from the positional information transmitted from the information processing terminal 130 and additionally specifies a single 3D model through processing of matching an image of the object acquired from the information processing terminal 130 and an image of the exterior of a 3D model corresponding to the specified object.

Accordingly, it is possible to specify a 3D model corresponding to an object in front of a user by performing simple processing, that is, narrowing down objects, using positional information and performing matching processing using an image of the narrowed object. In this case, a load is not applied to processing of the server 110 because objects can be easily narrowed down using positional information and matching processing can be performed using a limited number of images.

In addition, when the 3D model is a 3D model representing the entire earth, the specifying unit 306 acquires the positional information obtained from the information processing terminal 130 and azimuth information, specifies an object within the space of the whole 3D model on the basis of the positional information and the azimuth information and specifies a 3D model corresponding to the object. Meanwhile, although a single 3D model can also be specified in this case if detailed positional information is used, image matching processing may be executed in order to improve the accuracy of object recognition.

In addition, the specifying unit 306 may specify object information corresponding to a specified object. Object information includes the name of an object and inside information about the inside of the object. The name of an object may include, for example, the name of a store, the name of a facility, the name of a device, the name of equipment, or the like, and inside information may include, for example, business conditions of a store, a category of products for sale, the names of products for sale, prices, the names of components in a device, a room type of an accommodation, and the like.

The update unit 308 updates 3D models at a predetermined timing such that differences between an actual object and the inside of the object and a 3D model are generated as little as possible. For example, when an object is a store and there is one or a plurality of imaging devices (e.g., monitoring cameras) in the store, the update unit 308 performs image analysis on an image captured by each imaging device at a predetermined timing. Further, the update unit 308 may calculate an error between a current image and a previous image and perform image analysis if the error is equal to or greater than a predetermined value.

The update unit 308 updates product position information and product information in a store specified through image analysis in association with a 3D model of this object. Accordingly, a 3D model of a virtual space can be changed according to variation in an object of a real space. The update unit 308 may generate a 3D model from a plurality of images of the inside of an object.

In addition, the server 110 may cooperate with a reservation system of a store or a hotel. For example, a reservation system manages control information corresponding to each position (e.g., a seat or a room) inside an object that is a store such as a restaurant, a hotel, or the like. Here, the update unit 308 can associate a vacancy state (control information) of the seats of a store or rooms of a hotel with each position inside of a 3D model and the transmission unit 302 can transmit this control information of the object along with data of the 3D model and object information to an information processing apparatus 200.

Accordingly, control information of the inside of an object can be output and even without a user entering a store, for example, the user can be allowed to ascertain a vacancy state of seats of the store or a reservation state of rooms of a hotel.

Functional Configuration of Information Processing Terminal

FIG. 7 is a diagram showing an example of each function of the information processing terminal 130 according to the first embodiment. In the example shown in FIG. 7, the information processing terminal 130 includes a transmission unit 402, a reception unit 404, an acquisition unit 406, an estimation unit 408, a specifying unit 410, an output unit 412, and a detection unit 414. The transmission unit 402, the reception unit 404, the acquisition unit 406, the estimation unit 408, the specifying unit 410, the output unit 412, and the detection unit 414 can be realized by the CPU 202 of the information processing terminal 130 executing a program stored in the storage device 204. This program may be a program (application) which can be downloaded from the server 110 and installed in the information processing terminal 130.

The transmission unit 402 transmits predetermined information to the server 110 through the communication network N. The predetermined information may be positional information of the information processing terminal 130, a captured image of an object, and the like, for example.

The reception unit 404 receives predetermined information from the server 110 through the communication network N. The predetermined information may include at least data of a 3D model of an object, for example, and may include object information, control information, and the like.

The acquisition unit 406 acquires an image captured by the imaging unit 210 and positional information indicating the position of the information processing terminal 130. With respect to the positional information, the acquisition unit 406 may acquire the positional information of the information processing terminal 130 using a known GPS, beacon, or visual positioning service (VPS).

The estimation unit 408 estimates a sight-line direction of a user who uses the information processing terminal 130 on the basis of the positional information and sensor information measured by the sensor 212 including a magnetic sensor. For example, the estimation unit 408 estimates a position of the user in a received 3D model on the basis of the positional information and additionally estimates an azimuth direction from the position of the user in the 3D model as a sight-line direction on the basis of sensor information from an acceleration sensor and the magnetic sensor. In addition, with respect to a view-point position, the estimation unit 408 may estimate a position of a predetermined height from the ground of the position of the user in the 3D model as a view-point position of the user, for example. With respect to the predetermined height, the estimation unit 408 may set 165 cm or the like in advance or set the height of the user in advance. Further, the estimation unit 408 may estimate the view-point position on the basis of a captured image.

The specifying unit 410 specifies display data in a 3D model using a sight-line direction estimated by the estimation unit 408. For example, the specifying unit 410 can specify display data of a predetermined region in the 3D model by determining a position and a sight-line direction of the user in the 3D model. In addition, the specifying unit 410 can identify more appropriate display data by determining a sight-line direction from a view-point position of the user.

The output unit 412 outputs the display data specified by the specifying unit 410 using the output device 208. For example, when the output device 208 is a lens display, the output unit 412 may display the display data on the display. Further, the output unit 412 displays the display data in a space in front of the user if the output device 208 is a projector or the like and outputs the display data such that the display data is displayed on the retina of the user if the output device 208 is a retina projector.

Accordingly, it is possible to appropriately specify and display the inside of an object located at a position away from the user on the basis of the position of the user and an image of the object to reduce a gap from the appearance of a real space and allow the user to ascertain information on the inside of the object. For example, even when the user is walking on a street he or she does not know, the user can use a function by which he or she can see through to the inside of a store while remaining outside the store.

The detection unit 414 detects a first gesture (which is an example of a first operation) set in advance using an image captured by the imaging unit 210 or a predetermined device. A known device (e.g., S Pen of Galaxy Note, Ring ZERO, VIVE Controller, a globe type device, a myoelectricity sensor, or the like) which can recognize gestures may be used as the predetermined device. The detection unit 414 may detect a gesture according to a signal received from this device. The first gesture may be a gesture of making a circle with a hand, for example.

The transmission unit 402 transmits an image and positional information to the server 110 according to the first gesture. For example, when the detection unit 414 detects the first gesture, the detection unit 414 instructs an image and positional information acquired by the acquisition unit 406 to be transmitted to the server 110. Start of the above-described see-through function is triggered by detection of the first gesture.

Accordingly, the user can use the see-through function by making the first gesture at a preferred timing. In addition, by setting the first gesture to making a circle with a hand, the user can use the see-through function by making a circle with a hand and making a gesture of looking into the inside of a store.

In addition, the detection unit 414 may detect a second gesture of the user, for example, using an image or a predetermined device. The second gesture may be pointing with a finger and turning left or right, for example.

The output unit 412 may update a view-point position corresponding to a display magnification of display data or the display data according to the second gesture. For example, a display magnification increases when the second gesture is a right turn and decreases when the second gesture is a left turn.

In this case, the output unit 412 changes the display magnification of the display data according to a turning direction when the output unit 412 is notified of detection of the second gesture by the detection unit 414. In addition, a degree of a display magnification is adjusted according to the number of times the second gesture is performed and an operating time. For example, a display magnification may increase as the number of times the second gesture is performed increases or an operating time increases. Further, with respect to a display magnification, the same function can also be achieved by approaching or separating a view-point position (a position of a virtual camera) in a 3D model to or from an object.

Accordingly, the user can view the inside of an object from a distance or closely while remaining in the same place by performing the second gesture.

Furthermore, the output unit 412 may change the information amount of object information about an object and output the object information according to the second gesture. For example, when the object is a store, the output unit 412 may change the information amount of store information about the store corresponding to display data and display the store information. More specifically, the output unit 412 displays a large amount of store information or a small amount of the store information according to the second gesture.

Accordingly, a display magnification of display data and the information amount of store information to be displayed can be changed in connection with each other according to details of operation of the second gesture.

In addition, the output unit 412 may increase the information amount of object information and output the object information when display data is output in a direction in which the display data approaches the object according to the second gesture and decrease the information amount of the object information and output the object information when display data is output in a direction in which the object moves away according to the second gesture.

For example, store information is stored in such a manner that text information such as a store name, product genre names, product names, and product prices are hierarchized from a higher rank to a lower rank, and information is displayed from a higher rank to a lower rank as the display magnification increases (display information approaches the object) and thus more detailed information is displayed. On the other hand, information is displayed from a lower rank to a higher rank as the display magnification decreases (display information becomes far away from the object) and thus rougher information may be displayed. The method of storing data of store information is not limited thereto, and a priority may be assigned to information such that store information having a lower priority order is displayed as the display magnification increases. When information of a highest rank or a lowest rank is displayed, change in the information amount stops because there is no data higher or lower than the information.

Accordingly, the display magnification and the amount of displayed information can be changed in connection with each other according to the second gesture, and thus more detailed object information can be displayed if display data of augmented reality is extended and rougher object information can be displayed if the display data of the augmented reality is reduced.

In addition, the detection unit 414 may detect a third gesture set in advance in a state in which a view-point position corresponding to display data has been updated according to the second gesture. The third gesture may be a gesture of opening a hand, for example.

Here, the output unit 412 may switch any direction in an object to display data which can be output according to detection of the third gesture. For example, the output unit 412 may cause display data of 360 degrees from a view-point position (a position of a virtual camera) of a user on a 3D model space to be output by using the view-point position as a base point.

With respect to differences between functions realized by the second gesture and the third gesture, a sight-line position moves between a position of a user on a virtual space of a 3D model and a position of an object without changing a sight-line direction in the case of the second gesture, whereas a sight-line direction can be changed 360 degrees from a view-point position at a position of a third gesture detection timing in the case of the third gesture.

Accordingly, a user can look out over the inside of an object 360 degrees by performing the third gesture at a position on a virtual space inside the object, for example. The user can look out over the inside of the object 360 degrees on the virtual space while remaining outside the object in the real space.

The reception unit 404 may receive control information transmitted from an external system which manages control information corresponding to each position inside an object through the server 110. For example, when the server 110 specifies n object that is a display target, control information of the corresponding object is acquired from the external system. As an example, when the object is a restaurant or a hotel, the control information is reservation information on seats or vacancy information on rooms. The server 110 associates control information corresponding to each position with each position on a 3D model of the object and transmits the control information to the information processing terminal 130.

In this case, the output unit 412 may associate the received control information with each position inside the object of the 3D model and output the control information. For example, the output unit 412 may display vacancy information on a restaurant at a corresponding position of the 3D model. In addition, the output unit 412 may display vacancy information on a hotel at a corresponding position of the 3D model.

Accordingly, the user can ascertain control information on the inside of the object while remaining outside the object. For example, when the object is assumed to be a restaurant or a hotel, it is possible to ascertain vacancy information on a room while checking the position of the room without actually going to the hotel or calling the hotel.

When the object is a store, a 3D model may include products arranged on product shelves. When there is an imaging device such as a monitoring camera in the store, it is possible to specify a product by performing object recognition from an image from the imaging device or an image transmitted from another user. This specified product is included in the 3D model. Further, a manager or the like of the server 110 may set product shelves and products in the 3D model.

Accordingly, when the object is a store, the user can visually ascertain products sold in the store from the outside and also ascertain positions of products and the like before entering the store.

In addition, the output unit 412 may specify a position of an object in an image captured by the imaging unit 210 and output display data at the specified position. For example, the output unit 412 can adjust the outline of overlaid display data of a 3D model to the outline of an object in the real space and output the display data by specifying the outline of the actually captured object through edge extraction processing or the like.

Accordingly, the object on the real space and the object on a virtual space are displayed to a user such that positions thereof match each other, and thus the user can appropriately ascertain the inside of the object while feeling as if he or she actually sees through the object.

### Specific Examples

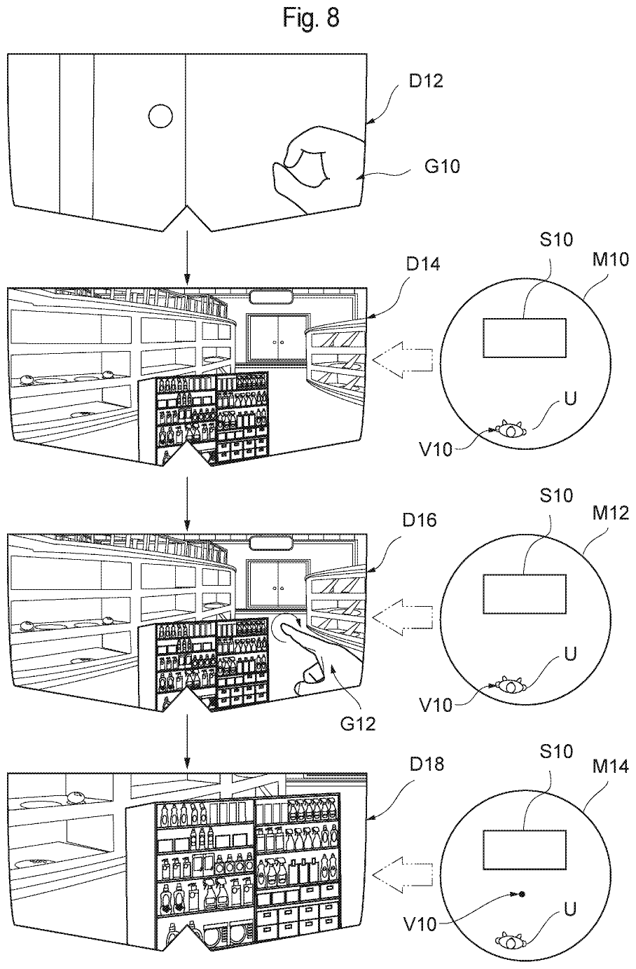

Next, respective functions according to embodiments will be described along with a method of viewing display data of a 3D model using FIGS. 8 to 11. In the examples shown in FIGS. 8 to 11, examples of scenes viewed by a user over a lens when the wearable terminal 130A is assumed to be smart glasses are represented.

FIG. 8 is a diagram for explaining an example of a see-through function and a display magnification change function according to the first embodiment. A scene beyond a lens D12 includes the exterior of a store of a real space and a state in which the first gesture G10 is performed with a hand. This first gesture is imaged by the imaging unit 210.

A scene beyond a lens D14 displays display data representing the inside of a 3D model of the store on a virtual space according to the first gesture (the see-through function is executed). Although the display data of the virtual space displayed on D14 is overlaid on the exterior of the store of the real space displayed on D12, in practice, scenes of the actual space will be omitted in description in examples below.

Here, the display data displayed on D14 is display data in an object direction (sight-line direction) from a view-point position V10 at a position of a user U in a 3D model M10 on the virtual space and display data of a store S10 of the 3D model.

A scene beyond a lens D16 includes the display data on the virtual space and a state in which the second gesture G12 is made with a hand. This second gesture is imaged by the imaging unit 210. The second gesture may be, for example, a gesture of pointing with a finger and turning the fingertip to the right. A gesture of turning a fingertip to the right represents enlargement and a gesture of turning a fingertip to the left represents reduction. A 3D model M12 on the virtual space at this time is the same as the 3D model M10.

Display data representing the inside of the 3D model of the store on the virtual space is displayed on a lens D18 with a changed display magnification according to the second gesture (the display magnification change function is executed).

Here, although the position of the user U does not change on the virtual space in the 3D model M14 on the virtual space, the view-point position V10 approaches in the object direction (sight-line direction). Display data of the store S10 of the 3D model, which is display data of the object viewed from the view-point position V10 after change, is displayed on the lens D18.

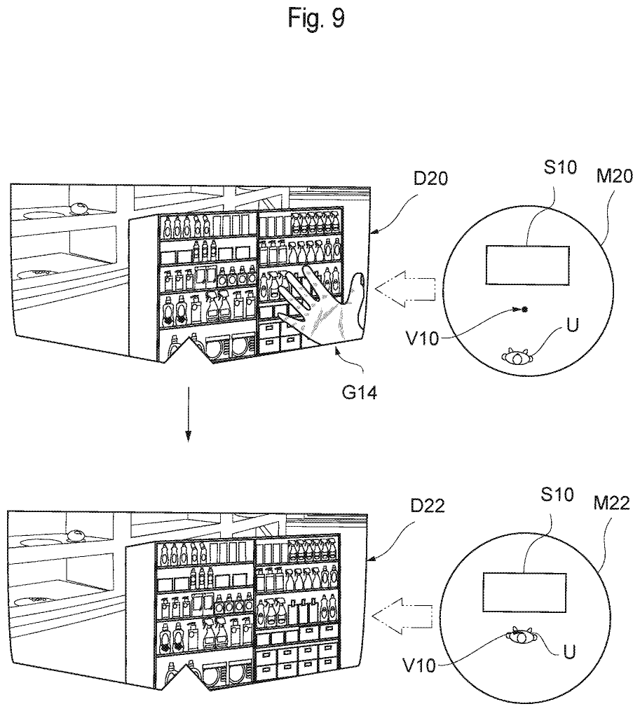

FIG. 9 is a diagram for explaining an example of a panorama function according to the first embodiment. In the example shown in FIG. 9, a scene beyond a lens D20 includes display data on the virtual space and a state in which the third gesture G14 is performed with a hand. This third gesture is imaged by the imaging unit 210. The third gesture may be, for example, a gesture of opening a hand. A 3D model M20 on the virtual space at this time is the same as the 3D model M14 shown in FIG. 8.

360-degree panorama display data can be displayed on a lens D22 from the view-point position of the 3D model of the store on the virtual space according to the third gesture (the panorama function can be used). For example, when the user turns right in the real space, display data on the virtual space when turning right as in the real space from the view-point position V10 of the 3D model is displayed.

Here, in a 3D model M22 on the virtual space, the position of the user U moves to the view-point position V10 on the virtual space and thus display data in any direction in 360 degrees from the view-point position V10 can be displayed.

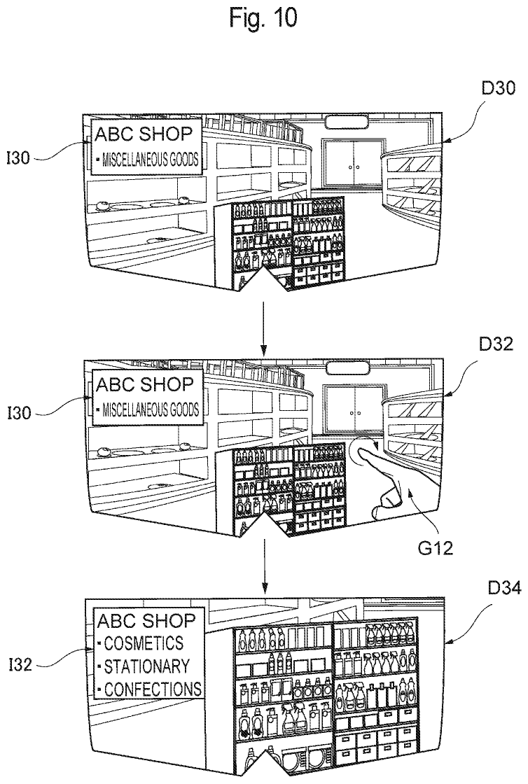

FIG. 10 is a diagram for explaining an example of a text display function according to the first embodiment. In the example shown in FIG. 10, a scene beyond a lens D30 includes display data on the virtual space and object information 130 about the object. The object information may be displayed along with the display data according to the first gesture, for example, or the object information may be displayed when an additional gesture is allocated and detected.

In the example shown in FIG. 10, the object information 130 may include, for example, a store name “ABC shop” and a category of products for sale “miscellaneous goods”. The example shown in FIG. 10 is merely an example and the present disclosure is not limited thereto.

A scene beyond a lens D32 includes a state in which the user performs the second gesture with a hand in addition to the scene beyond the lens D30. The output unit 412 controls a scene beyond a lens D34 to be displayed according to detection of the second gesture.

The scene beyond the lens D34 includes display data with an increased display magnification and more detailed object information 132. The object information 132 includes the store name “ABC shop” and products for sale. The products for sale are further subdivided and include cosmetics, stationery, confections, and the like. Accordingly, adjustment of the display magnification and the amount of displayed information is set for one gesture and thus functions with improved convenience for users can be provided.

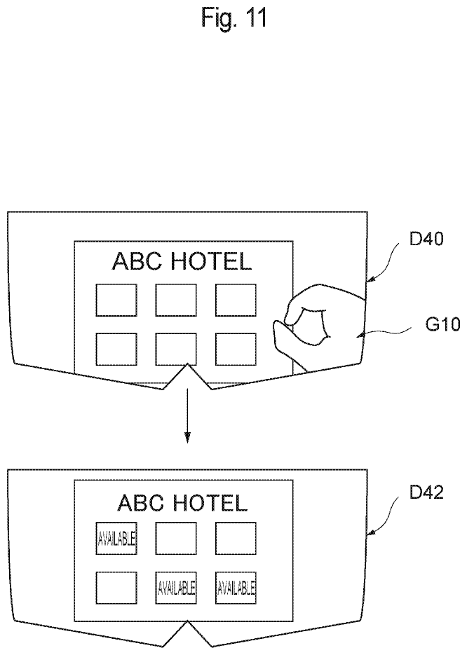

FIG. 11 is a diagram for explaining an example of a control information confirmation function according to the first embodiment. In the example shown in FIG. 11, a scene beyond a lens D40 includes a scene of the real space (a scene including a hotel) and a state in which the first gesture is performed. The output unit 412 outputs display data of a 3D model and control information of each position inside the object (vacancy information on each room of the hotel) according to the first gesture.

Although an example in which a scene beyond a lens D42 displays virtual control information on the real space is shown, display data of the inside of the object may be additionally output. In the example shown in FIG. 11, the user can ascertain which room is actually vacant using the control information overlaid on the real space.

Furthermore, if a gesture of designating a room and a gesture of making a reservation are set in advance and user information such as the name, address, telephone number and the like of the user is set in advance, it is possible to transmit the set user information to an external system which manages rooms of the hotel by selecting a room from the scene beyond the lens D42 and performing the gesture of reserving a room, and thus it is possible to seamlessly execute confirmation of vacancy information to reservation.

Operation

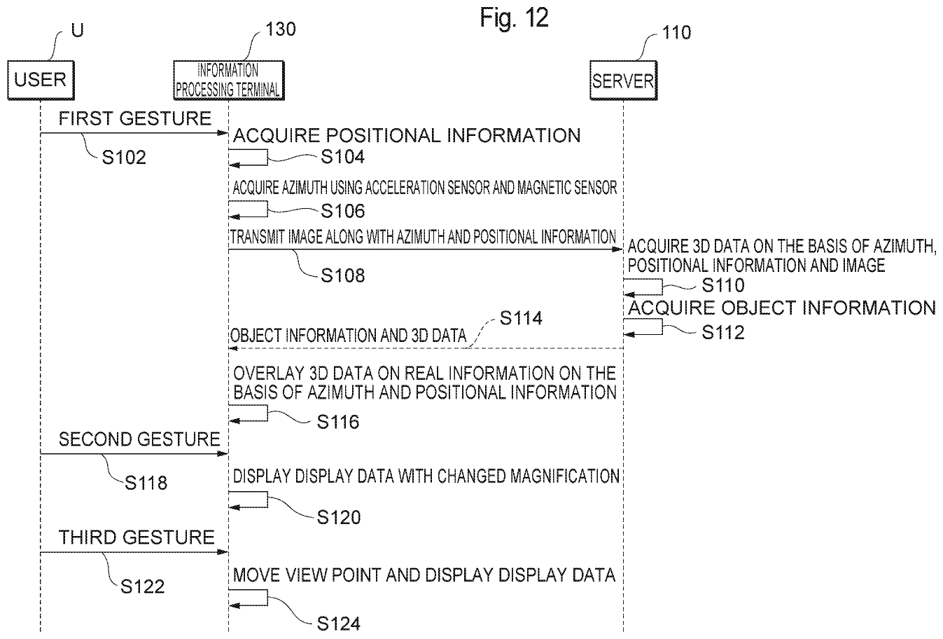

FIG. 12 is a sequence diagram showing an example of processing performed by the communication system 1 according to the first embodiment. Processing with respect to each function of the information processing terminal 130 according to each gesture will be described using FIG. 12.

In step S102, a user performs the first gesture. The imaging unit 210 of the information processing terminal 130 images this first gesture. The first gesture is detected by the detection unit 414.

In step S104, the acquisition unit 406 of the information processing terminal 130 acquires positional information of the information processing terminal 130. It is desirable to acquire the positional information using a GPS function, a beacon, or the like.

In step S106, the acquisition unit 406 of the information processing terminal 130 acquires azimuth information using the sensor 212 including an acceleration sensor and a magnetic sensor. It is possible to acquire appropriate azimuth information by correcting an inclination of the magnetic sensor using information of the acceleration sensor.

In step S108, the transmission unit 402 of the information processing terminal 130 transmits an image captured by the imaging unit 210 along with the azimuth information and the positional information to the server 110.

In step S110, the specifying unit 306 of the server 10 acquires 3D data of an object on the basis of the received azimuth information and the positional information. For example, the specifying unit 306 may narrow down objects to one or a plurality of objects through the positional information and the azimuth information and specify a single object using image pattern matching.

In step S112, the specifying unit 306 of the server 110 acquires object information corresponding to the specified object.

In step S114, the transmission unit 302 of the server 110 transmits data of the 3D model of the object and the object information to the information processing terminal 130.

In step S116, the estimation unit 408 of the information processing terminal 130 estimates a view-point position and a sight-line direction within a virtual space on the basis of the positional information and the azimuth information of the information processing terminal 130, the specifying unit 410 specifies display data displayed in the 3D model at the estimated view-point position and in the estimated the sight-line direction, and the output unit 412 outputs the specified display data over the real space (execution of the see-through function). There are various output methods as described above.

In step S118, the user performs the second gesture. The imaging unit 210 of the information processing terminal 130 images the second gesture. The second gesture is detected by the detection unit 414.

In step S120, the output unit 412 of the information processing terminal 130 outputs display data with a display magnification changed according to the second gesture (execution of the display magnification change function).

In step S122, the user performs the third gesture. The imaging unit 210 of the information processing terminal 130 images the third gesture. The third gesture is detected by the detection unit 414.

In step S124, the output unit 412 of the information processing terminal 130 allows 360-degree display from the view-point position of the virtual space according to the third gesture and then outputs display data in the direction of the user according to the direction of the user (execution of the panorama function).

Meanwhile, since the azimuth information is not data necessary for specifying a 3D model in step S110, as described above, the azimuth information may not be transmitted in step S108. In addition, the display magnification change function and the panorama function are arbitrary functions in the present embodiment.

### Second Embodiment

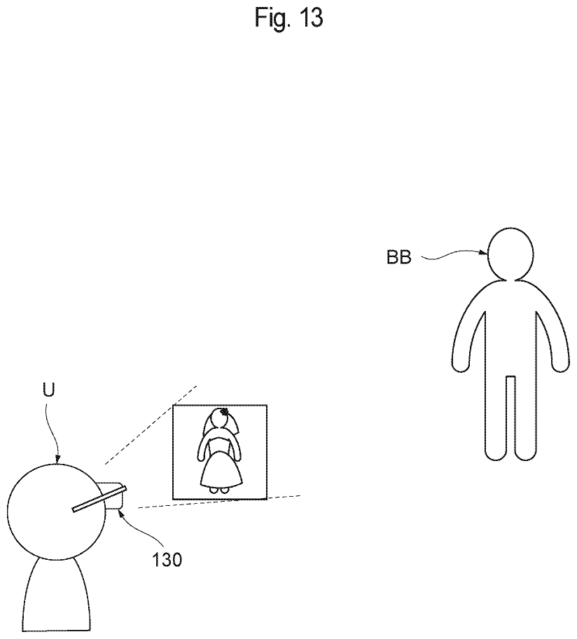

A configuration of a communication system according to a second embodiment will be described focusing on differences from the first embodiment with reference to FIGS. 13 to 15. FIG. 13 is a diagram for explaining a system overview according to the second embodiment. In the present embodiment, when a user U wearing the information processing terminal 130 performs a simple operation such as a gesture while viewing another person BB, the information processing terminal 130A transmits positional information and an image of the person BB to the server 110.

The server 110 identifies user information of the person BB on the basis of the positional information and the image of the person BB. Further, the server 110 acquires a three-dimensional model of clothes and ornaments overlaid on the person BB on the basis of the user information of the user U and the identified user information of the person BB and transmits data of the three-dimensional model to the information processing terminal 130. Processing thereafter is the same as the first embodiment.

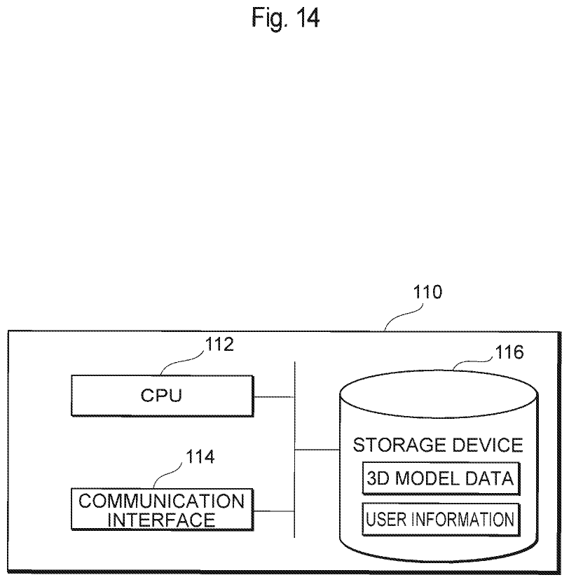

Next, FIG. 14 is a diagram showing an example of a hardware configuration of the server 110 according to the second embodiment. The storage device 116 of the server 110 according to the present embodiment stores user information instead of object information in the first embodiment. User information includes information such as an identifier, attributes (age, sex, residence, and communities to which a user belongs) and favorite products of a user. User information can be registered by the user U and the person BB operating their terminals.

Other parts of the hardware configuration of the server 110 are the same as those of the first embodiment.

Next, a functional configuration of the server 110 according to the present embodiment will be described. In the present embodiment, the specifying unit 306 specifies data of a single three-dimensional model (3D model) using a captured image of an object (person), positional information and user information from among data of 3D models of a plurality of clothes and ornaments (e.g., clothes, hats, accessories, shoes, and the like) stored in the storage device 116. Meanwhile, three-dimensional models of clothes and ornaments do not consider presence or absence of animations and bones and whether rigging and skinning have been performed.

For example, the specifying unit 306 may change a 3D model to be selected on the basis of a relationship between the user U wearing the wearable terminal 130A and the object (person BB) (whether information representing that the user U and the person BB belong to the same community has been registered in the user information, whether they have the same sex and age, and the like). More specifically, the specifying unit 306 may select a 3D model of a suit when the person BB is a student and the user U is an interviewer of a company for which the person BB has applied and select a 3D model of a casual fashion when the user U is a student of the same school as that of the person BB, for example. Further, the specifying unit 306 may select a 3D model of a uniform of a delivery company if the positional information of the user U is the residence of the user U and information representing that the person BB is a delivery person who delivers a parcel to the user U has been recorded as attribute information in the user information of the object (person BB) and may not select the 3D model if not.

In this manner, the specifying unit 306 changes a 3D model to be selected according to user information such that the user U of the wearable terminal 1301 can view attributes of the object (person BB) and a relation with the user U.

Other parts of the functional configuration of the server 110 are the same as those of the first embodiment.

Next, a functional configuration of the information processing terminal 130 according to the present embodiment will be described. The specifying unit 410 according to the present embodiment can track the body of an object (person) from an image captured by the imaging unit 210 in real time and specify a display position of a 3D model. Specifically, the specifying unit 410 detects feature points of the body, such as the nose, eyes, ears, neck, shoulders, elbows, wrists, waist, knees and ankles, from an image captured by the imaging unit 210 using a conventional human body posture estimation technology. Meanwhile, when the information processing terminal 130 includes an infrared depth sensor, feature points may be detected by calculating the deepness of infrared rays. In addition, a method of storing feature points of a human body detected through human body posture estimation may be a two-dimensional or three-dimensional method.

When bones with respect to a human body have been associated with a 3D model acquired from the server 110, the bones are linked to positions of feature points (shoulders, elbows, and the like) detected from the human body to specify a display position of the 3D model. On the other hand, when the bones with respect to the human body have not been associated with the 3D model acquired from the server 110, a position set by the person BB in advance is specified as a display position of the 3D model. In this case, it is desirable that information about the display position be linked to the user information stored in the storage device 116 and information about the linked display position be acquired from the server 110.

Meanwhile, when a 3D model of clothes is displayed on the person BB and the user U views the 3D model from the front, for example, the user U cannot view the lining part of the back of the clothes. Accordingly, it is desirable that the specifying unit 410 acquire the surface of the human body from the image captured by the imaging unit 210 using a technology such as semantic segmentation and do not display the lining part of the back using a technology such as occlusion, culling, or the like.

Other parts of the functional configuration of the information processing terminal 130 are the same as those of the first embodiment.

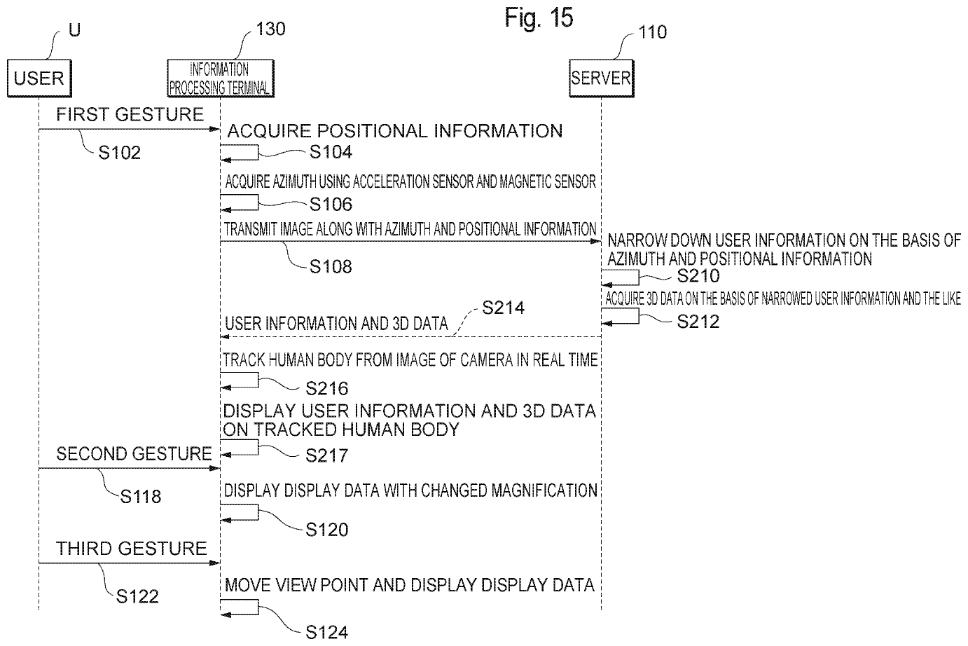

FIG. 15 is a sequence diagram showing an example of processing performed by the communication system 1 according to the second embodiment. Differences of a processing flow from the first embodiment will be described using FIG. 15.

When the transmission unit 402 of the information processing terminal 130 transmits an image captured by the imaging unit 210 along with azimuth information and positional information to the server 110 in step S108, the specifying unit 306 of the server 110 narrows down user information of an object (person) on the basis of the received positional information and image in step S210.

In step S212, the specifying unit 306 acquires a 3D model corresponding to the object (person) on the basis of the positional information, the image and the narrowed user information.

In step S214, the transmission unit 302 of the server 110 transmits data of the 3D model corresponding to the object (person) and the user information to the information processing terminal 130.

In step S216, the specifying unit 410 of the information processing terminal 130 tracks the body of the object (person) from the captured image in real time and specifies a display position of the 3D model. Then, the specifying unit 410 displays data of the 3D model and the user information at the specified display position (on the body of the person) in step S217.

Other processing flow of the communication system 1 are the same as those of the first embodiment.

### Third Embodiment

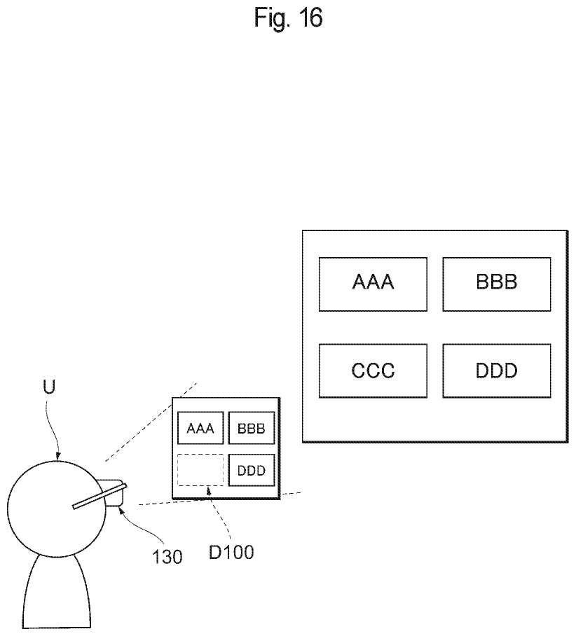

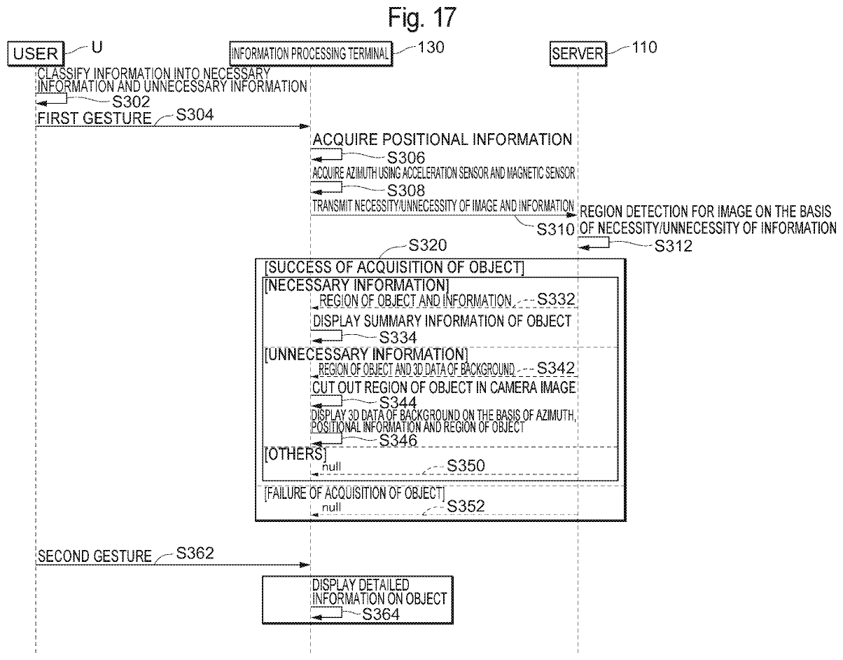

A configuration of a communication system according to a third embodiment will be described focusing on differences from the first embodiment with reference to FIGS. 16 and 17. FIG. 16 is a diagram for explaining a system overview according to the third embodiment. In the present embodiment, when the user U wearing the information processing terminal 130 performs a simple operation such as a gesture while viewing a certain scene, the information processing terminal 130A transmits positional information and an image of the scene to the server 110. In the example shown in FIG. 16, it is assumed that four signs AAA, BBB, CCC and DDD are attached to a wall and the user U views these signs using the information processing terminal 130. Here, the user U designates an object (e.g., the sign CCC) the user U wants to remove from the scene. When the server 110 receives information on the object that is a removal target, the server 110 specifies a position of a 3D model to be positioned behind the object that is the removal target and transmits display data D100 (e.g., the wall behind the sign CCC) of the 3D model at the position to the information processing terminal 130.

When the information processing terminal 130 receives the display data D100 of the object that is the removal target from the server 110, the information processing terminal 130 removes the object that is the removal target from the image and controls the display data D100 to be displayed at the position of the object. Meanwhile, an object that is a removal target may be designated by the user each time or a category, features on an image, and the like of the object that is the removal target may be stored in advance in the server 110 and specified through object detection or the like. Meanwhile, the information processing terminal 130 may overlay the display data D100 on the object that is the removal target even if the object is not removed from the image.

Accordingly, information unnecessary for the user and information on an object that is not desired to be seen by another person when the other person uses the information processing terminal 130 can be removed, and thus a viewer who uses the information processing terminal 130 can select information. For example, information unnecessary for the user can be removed from a large amount of information, and when children use the information, information inappropriate for education of the children can be removed. Meanwhile, as a method for causing unnecessary information or information inappropriate for education not to be viewed, a method for overlaying, for example, additional information on the corresponding information to hide the corresponding information, or the like may be conceived. However, when additional information is overlaid to hide the information, the user realizes that something is hidden. In this case, the user may remove the information processing terminal 130 and intend to check hidden information. It is possible to make the user not even notice that information is hidden by removing unnecessary information or information inappropriate for education by overlaying a background on the information as in the present embodiment.

In the third embodiment, the hardware configurations of the server 110 and the information processing terminal 130 are the same as the hardware configuration in the first embodiment and thus description thereof is omitted. Next, a functional configuration of the server 110 will be described. Although the functional configuration of the server 110 according to the third embodiment is the same as that of the server 110 shown in FIG. 6, differences therebetween will be chiefly described.

The reception unit 304 receives object information that is a removal target (hereinafter also referred to as “removal object information”) from the information processing terminal 130. When this removal object information is received, the specifying unit 306 specifies a position of a 3D model in a background that is the position of the removal object information. Meanwhile, the 3D model may be specified using a received image and positional information as described in the first embodiment. The transmission unit 302 transmits display data corresponding to the position of the specified 3D model to the information processing terminal 130. Further, the transmission unit 302 may transmit 3D model data and positional information in the specified 3D model to the information processing terminal 130 as in the first embodiment. In this case, the information processing terminal 130 specifies display data of the 3D model on the basis of the received positional information and controls the display data such that it is displayed over the removal object information.

In addition, the server 110 may store the removal object information in association with a user ID or the like. In this case, the reception unit 304 receives an image and positional information as in the first embodiment and additionally receives the user ID. With respect to the user ID, the reception unit 304 receives a user ID or the like used when this application is logged in. Next, the specifying unit 306 sets removal object information of this user in advance on the basis of the user ID, searches for objects in the image, and determines whether an object corresponding to the removal object information is in the image. If the removal object information is in the image, the same processing as the above-described processing is performed.

Meanwhile, the specifying unit 306 may assign labels to respective pixels using a method such as semantic segmentation and perform object detection by dividing the pixels into a plurality of regions on the basis of the labels as an example of object detection. For example, the specifying unit 306 may specify a region corresponding to a divided region as an object.

Next, a functional configuration of the information processing terminal 130 according to the third embodiment will be described. Although the functional configuration of the information processing terminal 130 according to the third embodiment is the same as that of the information processing terminal 130 shown in FIG. 7, differences therebetween will be chiefly described.

When the user designates removal object information on an image captured by the imaging unit 210, the acquisition unit 406 acquires object information including a position designated by edge detection or the like from the designated position on the image. Meanwhile, a known technology may be used as a method for detecting an object. With respect to designation of removal object information, a position of an object may be represented and designated by a predetermined gesture or the removal object information may be designated by a user using an operation button or the like. The transmission unit 402 transmits the removal object information to the server 110 when the removal object information is designated by the user.

The reception unit 404 receives display data corresponding to a background of the removal object information from the server 110. In this case, processing of the estimation unit 408 and the specifying unit 410 may not be performed and the output unit 412 outputs the received display data at the position of the removal object information. When the output device 208 is a display, the output unit 412 may display the display data over the position of the removal object information in an image. In addition, the output unit 412 may remove the removal object information in the image and then output the display data at that position. In this case, since the object can be completely removed on the image, the user can view the display data of the 3D model without realizing that the object has been removed when viewing the real world using a lens display. Further, when the output device 208 is a projector, the output unit 412 sets a region of the display data as an impermeable region as far as possible such that the object that is the actual removal target cannot be seen.

In addition, the reception unit 404 may receive 3D model data and positional information representing a position in the identified 3D model. In this case, the specifying unit 410 specifies a position in the 3D model on the basis of the positional information of the object and specifies display data on the basis of the specified position and the size of the removal object information. The output unit 412 executes the above-described output processing using the specified display data. Accordingly, by specifying the position of the removal object information on the side of the information processing terminal 130, the information processing terminal 130 can display the display data of the 3D model without disharmony even when the position of the user changes and an angle at which the user views the object that is the removal target changes.

Next, processing according to the third embodiment will be described, FIG. 17 is a sequence diagram showing an example of processing performed by the communication system 1 according to the third embodiment. Differences from the processing flow of the first embodiment will be described using FIG. 17.

In step S302, a user performs an operation with respect to whether to classify information into necessary information and unnecessary information. For example, the user may instruct the information processing terminal 130 to classify information into necessary information and unnecessary information by designating an object that is a removal target on an image. The acquisition unit 406 of the information processing terminal 130 may determine that classification of information into necessary information and unnecessary information is not necessary if there is no instruction from the user and receive designation of an object whose information is necessary from the user. In addition, the acquisition unit 406 may acquire whether classification of information into necessary information and unnecessary information is necessary according to attributes and a behavior history of the user. For example, when the user sets that classification of information into necessary information and unnecessary information is necessary in advance, the acquisition unit 406 acquires the necessity of classification of information into necessary information and unnecessary information when this application is started. Further, when the user has indicated that classification of information into necessary information and unnecessary information is necessary a predetermined number of times as a behavior history of the user, the acquisition unit 406 acquires the necessity of classification of information into necessary information and unnecessary information after the number of times.

Steps S304, S306 and S308 are the same as steps S102, S104 and S106 shown in FIG. 12. Meanwhile, the first gesture of step S304 may be a different gesture from the first gesture in the first embodiment and processing in the first embodiment and processing in the third embodiment may be distinguished from each other by gestures and both implemented.

In step S310, the transmission unit 402 of the information processing terminal 130 transmits a captured image and information representing whether to classify information into necessary information and unnecessary information to the server 110. Here, it is assumed that classification of information into necessary information and unnecessary information is performed.

In step S312, the specifying unit 306 of the server 110 performs region detection (object detection) on the image on the basis of necessity or unnecessity of information. As region detection, semantic segmentation may be executed.

In step S320, the specifying unit 306 of the server 110 specifies whether information on a detected region (or object) is necessary. For example, when the user designates an object that is a removal target, it is assumed that information about a region corresponding to the object is unnecessary and information about regions corresponding to other objects is necessary, and processing when information is necessary (steps S332 to S334) or processing when information is not necessary (steps S342 to S346) is repeated until there is no detected region.

In step S332, the specifying unit 306 of the server 110 specifies a region of the detected object and information about the region (e.g., information associated with the name of the object) and the transmission unit 302 transmits this information to the information processing terminal 130.

In step S334, the output unit 412 of the information processing terminal 130 may output summary information from among information acquired by the reception unit 404. Meanwhile, the summary information may not be necessarily output.

In step S342, the specifying unit 306 of the server 110 specifies the region (position and size) of the object and a 3D model of a background of the object and the transmission unit 302 transmits this information to the information processing terminal 130.

In step S344, the output unit 412 of the information processing terminal 130 removes the region of the received object by cutting out the region in the image.

In step S346, the output unit 412 of the information processing terminal 130 controls display data of the 3D data of the background to be displayed on the basis of the azimuth, positional information, and region information of the object. For example, the specifying unit 410 may obtain a view point and a sight-line direction with respect to the 3D model from the azimuth and the positional information and specify a display surface of the 3D model. Next, the specifying unit 410 specifies a region of the display surface which will be displayed on the basis of information on the position and size included in the region information of the object and specifies the region as display data.

In step S350, the transmission unit 302 of the server 110 transmits “null” to the information processing terminal 130 when necessity or unnecessity of information has not been set with respect to the detected region.

In step S352, the specifying unit 06 of the server 110 transmits “null” to the information processing terminal 130 when detection of the region of the object has failed.

In step S362, the user performs the second gesture. The imaging unit 210 of the information processing terminal 130 images the second gesture. The second gesture is detected by the detection unit 414.

In step S364, the output unit 412 of the information processing terminal 130 changes a display magnification according to the second gesture and controls detailed information on the object to be displayed, for example. Further, when the third gesture is made, the processing with respect to the third gesture shown in FIG. 12 may be executed.

Next, specific application examples according to the third embodiment will be described. Since unnecessary information can be removed in the third embodiment, it may be conceived that, in a school, for example, a 3D model of the campus is prepared in advance, unnecessary information is removed using the 3D model, necessary information is left and the campus is explained when the campus is explained to freshmen, guardians and the like.

In addition, when a user collects and organizes useless items in a house, in order to save and explain only items (exhibited items) the user wants to sell, the user can explain only the exhibited items by removing items which are not exhibited and displaying a part of a 3D model of the house on a region of furniture and the like which are not exhibited.

Further, when a user has a meal at a restaurant, it is possible to remove guests other than the persons concerned and produce a feeling of privacy. In this case, if there is no 3D model of the restaurant and images of a monitoring camera installed in the restaurant can be acquired by the server 110, it is possible to generate a background image when guests have been removed by storing background images and the like when there is no guest using the images.

In addition, if a 3D model can be created outdoors in real time using a camera image acquired from an autonomous vehicle or the like (e.g., the technology of NVIDIA Corporation; reference URL: https://www.theverge.com/2018/12/3/18121198/ai-generated-video-game-graphics-nvidia-driving-demo-neurips), it is possible to remove unnecessary information using the 3D model created in real time for a user close to the autonomous vehicle.

Furthermore, in case of route search or when a franchise or a target place such as a store that a user ants to go is displayed as a map on a lens display or the like, unnecessary information can also be removed.

Moreover, when a user performs product explanation or the like by projecting his/her image thereon, it is also possible to remove the image of the user, replace the image of the user by other data (e.g., an avatar of a small animal or the like) and display the other data. This can be realized by using an avatar or the like instead of a 3D model of a background in the above-described technology. That is, this avatar or the like performs product explanation instead of the user. For example, the server 110 may store a 3D model of an avatar in association with a predetermined user ID, and if image information or the like is received from the predetermined user, transmit the model of the avatar to the information processing terminal 130 such that the avatar is displayed at a position in removal object information. Accordingly, it is possible to induce a user who does not want to display himself/herself to use this service.

In addition, in the above-described case of product explanation, a user can remove predetermined things in his/her room and display a part of a 3D model of the room instead of the things in order to show the room neatly.

Furthermore, in the case of visiting a factory, it is possible to reduce a risk of leakage of confidential information by allowing visitors to use the information processing terminal 130 and eliminating confidential information in the factory. In this case, if images of a monitoring camera or the like in the factory can be used, a region or an object in the background of confidential information may be specified in an image of the monitoring camera and the specified region or object may be displayed.

Meanwhile, the present disclosure is not limited to the above-described embodiments and can be implemented in various other forms without departing from essential characteristics of the present invention. Accordingly, the above embodiments are to be construed in all aspects as illustrative and not restrictive. For example, the order of the above-described processing steps may be changed or the processing steps can be executed in parallel within a range in which no inconsistency occurs in details of processing.

A program according to each embodiment of the present disclosure may be provided in a state in which the program has been stored in a computer-readable storage medium. The storage medium can store the program in a “non-transitory tangible medium”. The program includes a software program or a computer program as an example that is not limited.

### Modified Examples

Although the server 110 transmits a specified 30 model to the information processing terminal 130 in the above-described embodiments, screen information of display data of the specified 3D model may be transmitted. In this case, the server 110 may receive information on a view-point position and a sight-line direction from the information processing terminal 130 and transmit screen information of display data of a 3D model updated using the information to the information processing terminal 130. Accordingly, a processing load of a terminal side can be reduced.

In addition, when an object is a store, the server 110 can allow a user to purchase a product by cooperating with a sales system of the store. For example, when the user performs a gesture of selecting a product in a 3D model overlaid on the actual space, the server 110 specifies the product that is the target of the gesture by performing object recognition. With respect to object recognition, the server 110 specifies a product having a smallest error by performing pattern matching using a database having correct images of products, or the like. Thereafter, the server 110 transmits identification information of the specified product (e.g., a product name, a JAN code of the product, and the like) along with user information to the sales system. The user information may include the name and address of the user and payment information such as a bank account and a credit number. Accordingly, the user can specify and purchase a product in the store while remaining outside the store and thus can reduce his/her time and efforts.

Furthermore, with respect to estimation of a sight-line direction, if an imaging device can image the eyes of a user, the information processing terminal 130 may acquire an image obtained from the imaging device, recognize the eyes from the image and estimate a sight-line direction from the recognized eyes, in addition to the method of using an acceleration sensor and a magnetic sensor.

In addition, with respect to an operation performed on the wearable terminal 130A, the configuration in which the detection unit 414 detects a gesture of a user and updates display data output by the output unit 412 according to the detected gesture has been described in the above-described embodiments, but the present disclosure is not limited thereto. For example, when the detection unit 414 includes a speech recognition function, the wearable terminal 130A may be operated using a speech of a user (“I want to check the inside”, “I want to enlarge” or the like). Further, the detection unit 414 may detect that the positional information of the information processing terminal 130 has been updated (the information processing terminal 130 approaches an object or moves away from the object) and update display data output to the output unit 412.

Furthermore, when the specifying unit 306 of the server 110 performs processing of matching an image of an object acquired from the information processing terminal 130 and an image of the exterior of a 3D model corresponding to a specified object, for example, the specifying unit 306 may use features of the object (text and corporate colors, for example, in the case of a building, and an age, sex, height, and hair color and length, for example, in the case of a person). In this case, it is desirable to set features of an object in object information in advance on the basis of a picture of the object and input of a user.

Moreover, although an example in which the see-through function becomes effective when the detection unit 414 detects the first operation has been described in the above-described embodiments, the present disclosure is not limited thereto. The see-through function may be automatically validated when power is applied to the information processing terminal 130.

What is claimed is:

1. An information processing method performed by an information processing terminal, comprising:
acquiring an image captured by an imaging unit and positional information representing a position of the information processing terminal;
transmuting the image and the positional information to an information processing apparatus;
receiving, from the information processing apparatus, data of a three-dimensional model of an object specified using the image and the positional information;
estimating a sight-line direction of a user who uses the information processing terminal on the basis of sensor information measured by an acceleration sensor and a magnetic sensor;
specifying display data of the three-dimensional model using the sight-line direction; and
outputting the display data.

2. The information processing method according to claim 1, wherein
the information processing terminal further executes
detecting a first operation set in advance, and
transmitting comprises
transmitting the image and the positional information to the information processing apparatus according to the first operation.

8. The information processing method according to claim 1, wherein
the information processing terminal further executes
detecting a second operation set in advance and
updating a display magnification of the display data or a view-point position corresponding to the display data according to the second operation.

4. The information processing method according to claim 3, wherein
the information processing terminal further executes
changing the information amount of object information about the object and outputting the object information according to the second operation.

5. The information processing method according to claim 4, wherein
changing the information amount of the object information and outputting the object information comprise
increasing the information amount of the object information and outputting the object information when display data is output in a direction in which the display data approaches the object.

6. The information processing method according to claim 3, wherein
the information processing terminal further executes:
detecting a third operation set in advance in a state in which the view-point position corresponding to the display data has been updated according to the second operation; and
switching any direction inside the object to display data that can be is outputtable according to the third operation.

7. The information processing method according to claim 1, wherein
the information processing terminal further executes:
receiving control information transmitted from an external system which manages the control information corresponding to each position of the inside of the object through the information processing apparatus; and
outputting the control information in association with each position of the inside of the object.

8. The information processing method according to claim 1, wherein,
when the object is a store, the three-dimensional model includes products arranged on product shelves.

9. The information processing method according to claim 1, wherein
outputting the display data comprises specifying a position of an object in an image captured by the imaging unit and outputting the display data at the specified position.

10. The information processing method according to claim 1, wherein
the information processing terminal further executes acquiring removal object information representing an object that is a removal target, and
wherein specifying comprises
specifying display data of the three-dimensional model positioned in a background of the object that is the removal target on the basis of the removal object information.

11. The information processing method according to claim 10, wherein
outputting comprises
replacing the display data with predetermined data and outputting the predetermined data when the removal object information is predetermined object information,

12. A computer-readable non-transitory storage medium storing a program causing an information processing terminal to execute:
acquiring an image captured by an imaging unit and positional information representing a position of the information processing terminal;
transmitting the image and the positional information to an information processing apparatus;
receiving, from the information processing apparatus, data of a three-dimensional model of an object specified using the image and the positional information;
estimating a sight-line direction of a user who uses the information processing terminal on the basis of sensor information measured by an acceleration sensor and a magnetic sensor;
specifying display data of the three-dimensional model using the sight-line direction; and
outputting the display data.

13. An information processing terminal, comprising:
an imaging unit;
an acquisition unit which acquires an image captured by the imaging unit and positional information representing a position of the information processing terminal;
a transmission unit which transmits the image and the positional information to an information processing apparatus;
a reception unit which receives, from the information processing apparatus, data of a three-dimensional model of an object specified using the image and the positional information;
an estimation unit which estimates a sight-line direction of a user who uses the information processing terminal on the basis of sensor information measured by an acceleration sensor and a magnetic sensor;
a specifying unit which specifies display data of the three-dimensional model using the sight-line direction; and
an output unit which outputs the display data.
